(19) United States
(12) Patent Application Publication
(10) Pub. No.: US 2009/0271207 A1
(43) Pub. Date: Oct. 29, 2009

(54) Facility access management system

(76) Inventors: William P. Lanigan, Orland Park, IL (US); Maciej Labowicz, Roselle, IL (US); David S. Schuman, Naperville, IL (US); Eugene Zhukovsky, Homewood, IL (US); John Wepfer, Orland Park, IL (US); Gary A. Naese, Bonfield, IL (US)

Correspondence Address: Gary J. Cunningham, 620 Courtland Circle, Western Springs, IL, 60558, US

(21) Appl. No.: 12/150,453

(22) Filed: Apr. 29, 2008

(51) Int. Cl. G06Q 99/00; H04L 9/32

(52) U.S. Cl. 705/1; 340/5.2

(57) ABSTRACT

An enhanced delivery system (300) for field service providers is disclosed. In its simplest form, the delivery system (300), can comprise the steps of: granting (305) permission to a service provider to provide a designated service at an assigned location; traveling (310) to the assigned location to provide a service; remotely actuating (315) an access point to gain access to a restricted area; accessing (320) the restricted area through the access point; providing (325) a service in connection with the restricted area; and closing (330) the access point after accessing the restricted area. The system (300) facilitates and simplifies access to restricted areas, and contributes to routinizing the service process for enhanced efficiencies.

### BACKGROUND

This invention relates to facility access management system that will allow field and delivery personnel to work more efficiently.

Referring to FIG. 18 is a prior art daisy chain locking arrangement for allowing access to various disparate groups, such as field workers, access to a predetermined location. A series of mechanical keyed and combination padlocks or a daisy chain of locks, provides very little access control and management. Keys can be lost and combinations cannot be controlled. Disadvantageously, a terminated employee or contractor continues to have access to a facility when he or she retains a key or remembers a combination. A solution to this cumbersome process is provided by this invention.

A need exists for field and delivery workers to work more efficiently. A system that facilitates and simplifies access to restricted areas, and contributes to routinizing the service process would be an improvement in the art.

A more detailed explanation of the invention is provided in the following description and claims, and is illustrated in the accompanying drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a flow diagram of the delivery system for field and delivery workers, in accordance with the instant invention;

FIG. 2 is an interior view of an emergency exit door with associated structure, such as a control box, door opener, electric door strike and motion sensors, in accordance with the instant invention;

FIG. 3 is an exterior view of an emergency exit door with associated structure, such as a keypad and a typical RF (radio frequency) key fob in accordance with the instant invention;

FIG. 4 includes an exploded view of an embodiment with a preferred placement of the door opener mechanism, in accordance with the instant invention;

FIG. 5 shows an exploded view of a typical electric door strike and placement of door magnets, in accordance with the instant invention;

FIG. 6 includes an A-A view of an embodiment as depicted in FIG. 4, with a preferred actuator when the door is in a closed position, in accordance with the instant invention;

FIG. 7 includes an A-A view of an embodiment as depicted in FIG. 6, with a preferred actuator when the door is in a partially opened position, in accordance with the instant invention;

FIG. 8 includes an A-A view of an embodiment as depicted in FIG. 6, with a preferred actuator when the door is in a fully opened position, in accordance with the instant invention;

FIG. 9 includes an A-A view of an embodiment as depicted in FIG. 4, with a preferred actuator when the door is opened by a person using an emergency exit, and the door and door opener are substantially shown not in permanent contact, in accordance with the instant invention;

FIG. 10 includes an A-A view of an embodiment as depicted in FIG. 4, with a preferred actuator when the door is in a partially opened position, the door and door opener are substantially shown not in permanent contact, and shown with shock absorbing structure, in accordance with the instant invention;

FIG. 11 includes an A-A view of an embodiment as depicted in FIG. 10, with a preferred actuator when the door is in a partially opened position, the door and door opener are shown in contact, and shown with shock absorbing structure, in accordance with the instant invention;

FIG. 12 includes an A-A view of an embodiment as depicted in FIG. 10, with a preferred actuator when the door is in a closed position, the door and door opener are in contact and the latter still extended, and shown with shock absorbing structure, in accordance with the instant invention;

FIG. 13 includes an A-A view of an embodiment as depicted in FIG. 4, with a preferred actuator having a force centering roller and force centering adapter or interface, when the door is in a closed position, in accordance with the instant invention;

FIG. 14 includes an A-A view of an embodiment as depicted in FIG. 13, with a preferred actuator having a force centering roller and force centering adapter or interface, when the door is in a partially opened position and the actuator is still shown in contact with the door through the adapter, in accordance with the instant invention;

FIG. 15 includes an A-A view of an embodiment as depicted in FIG. 13, with a preferred actuator having a force centering roller and force centering adapter or interface, when the door is in a fully opened position, and the actuator is substantially not shown in contact with the door through the adapter, in accordance with the instant invention;

FIG. 16 includes an A-A view of an embodiment as depicted in FIG. 13, with a preferred actuator having a force centering roller and force centering adapter or interface, when the door is in a fully opened position, and the actuator in this embodiment is shown extended and in contact with the door through the adapter, in accordance with the instant invention;

FIG. 17 includes an A-A and B-B views of a preferred embodiment as depicted in FIG. 4, when the actuator is a pneumatic device, in accordance with the instant invention.

FIG. 18 is a prior art daisy chain locking system for allowing access to various disparate groups, such as field workers, access to a predetermined location.

FIG. 19 is an elevated perspective view of an exemplary site, in the form of a remote cell tower site, utilizing a facility access management system (FAMS), showing a fenced compound, secure building, shed and lockers, with strategically positioned access points, in accordance with the instant invention;

FIG. 20 is a flow diagram of an embodiment of a system for field service providers, in accordance with the instant invention;

FIG. 21 is a top view of a exemplary site utilizing a facility access management system (FAMS), showing a fenced compound, secure building, shed and lockers, cell tower and strategically positioned access points, in accordance with the instant invention;

FIG'S. 22 and 23 include an exploded view and a perspective view of an access point with associated structure, showing an exemplary access point for a road side access application or a chain link fence gate application, and are configured to receive an RF signal for unlocking, in accordance with the instant invention.

### DETAILED DESCRIPTION

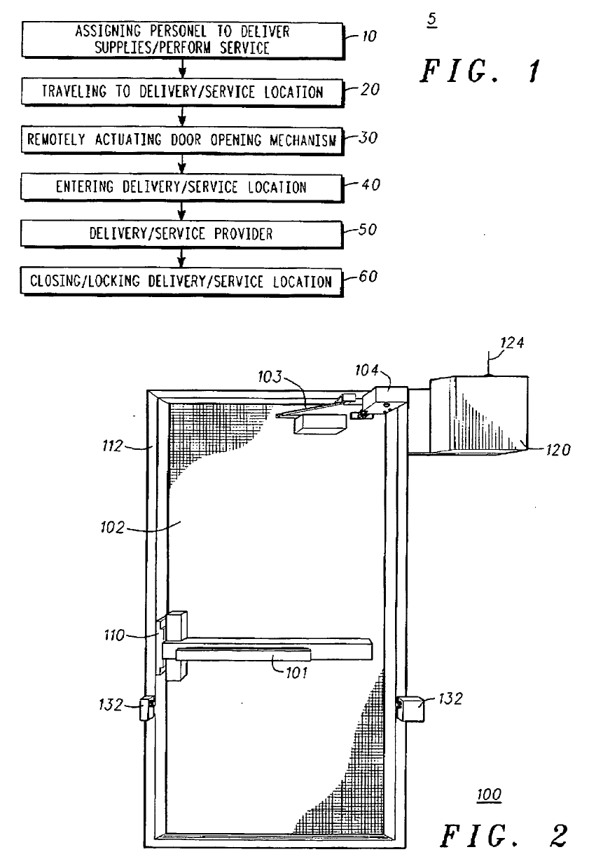

Turning now to the drawings, and more particularly to FIG. 1 thereof, a block diagram of a delivery system 5 is shown. In its simplest form, it includes the steps of: assigning field personnel to enable them to provide a delivery or service at a designated location 10 (hereafter assigning step 10); traveling to the designated location to provide an on-site delivery or service 20 (hereafter traveling step 20); remotely actuating an opening mechanism to open an emergency exit door 30 (hereafter actuating step 30); entering the designated location through the emergency exit door opening 40 (hereafter entering step 40); providing a delivery or service at the designated location 50 (hereafter providing step 50); and closing and locking the emergency exit door after the delivery or service has been substantially completed 60 (hereafter closing step 60). The delivery system disclosed here, is a more efficient and cost effective method then those presently known.

In more detail, the actuating step 30 includes an applying step, to provide a sufficient threshold force in a substantially outwardly direction and substantially perpendicular direction to the emergency exit door, to open the door. This step provides a simple and durable method and means of opening an emergency exit door.

In a preferred embodiment, the applying step includes application of a sufficient threshold force step, such as providing a force of at least about 20 lbs., depending on the position of such force, for a smooth and sufficient opening force, as shown in FIGS. 6 and 7. In a preferred embodiment, the applying step includes providing a force of at least 25 lbs. to about 300 lbs. or more, when applied in proximity to a hinge, for an efficient and sufficient opening force.

In more detail, the remotely actuating step 30 can include the steps of: applying a sufficient threshold force in a substantially outwardly direction and substantially perpendicular direction to the emergency exit door; providing the threshold force in the substantially perpendicular direction ranging from zero degrees to about 30 degrees from the perpendicular direction of the emergency exit door; and minimizing a side load to an actuator, as shown in FIGS. 13, 14 and 16. This combination of steps, provides a smooth and efficient opening and can contribute to providing a longer useful life of the delivery system 5 and associated apparatus utilized herein.

In a preferred embodiment, providing the threshold force in the substantially perpendicular direction ranging from about zero degrees to about 20 degrees from the perpendicular direction, advantageously helps to minimize a disadvantageous side load to the actuator, relative to the actuating step 30. In such an embodiment, the side load is minimal or near zero at half stroke, which is beneficial to maximizing the useful life of the system and actuating step 30. Side loads or radial loads can reduce the life of actuator.

Also in a preferred embodiment, the actuating step 30 includes locating the outwardly pushing force at a location and position which is substantially minimally invasive to the emergency exit door opening, to allow free and unobstructed access through such door, as illustrated in FIG. 2. The locating step can include positioning the pushing force in proximity to an upper corner of the emergency exit door near a side of the door where hinges are normally located for free access through the door.

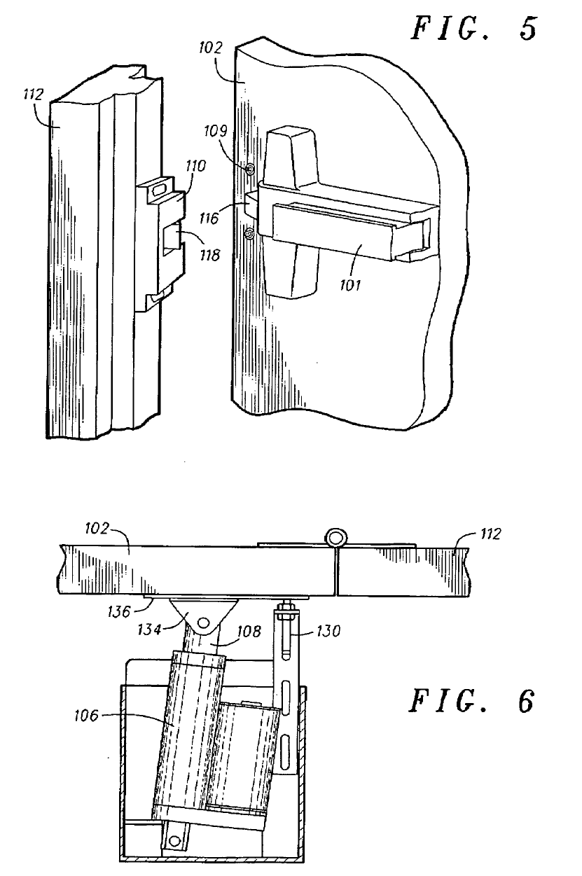

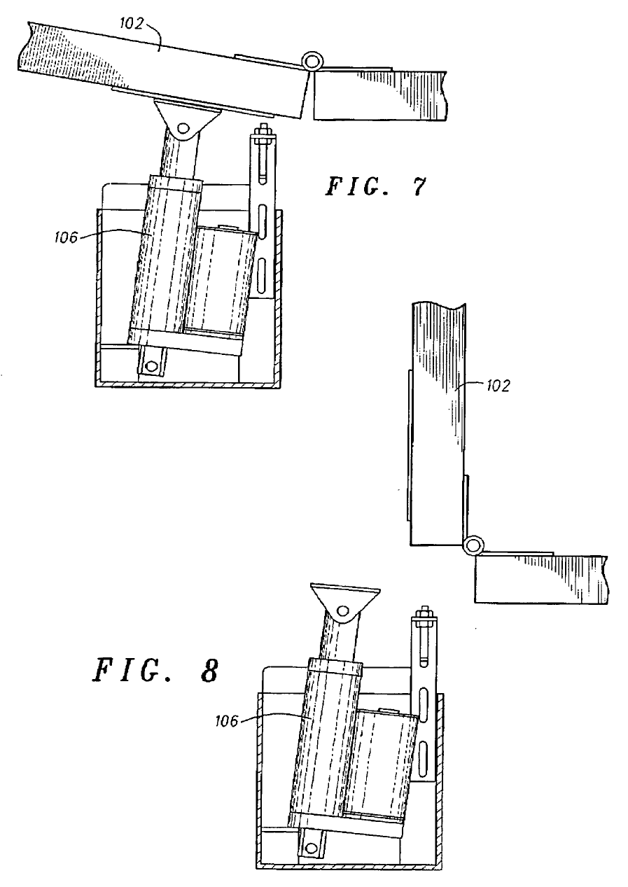

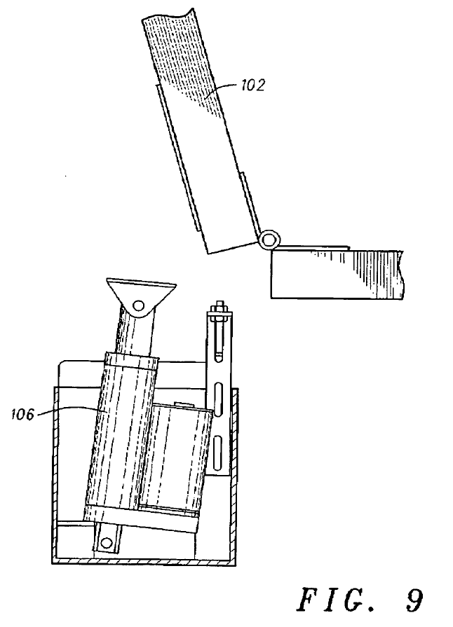

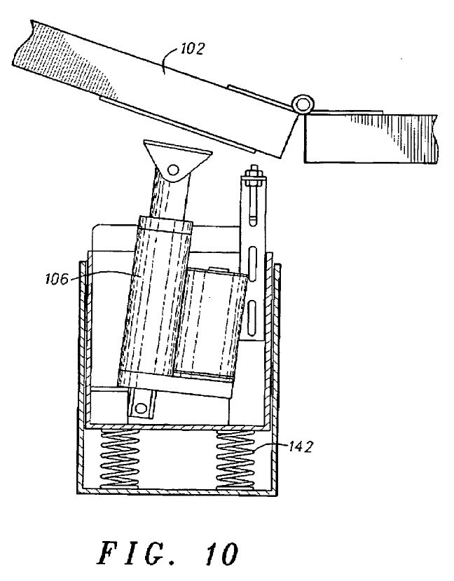

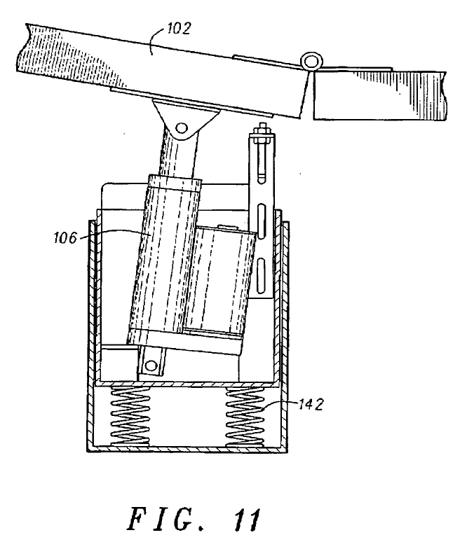

In one embodiment, the actuating step includes: applying a sufficient threshold force in an outwardly direction and in a substantially perpendicular direction to the emergency exit door (FIG. 6); energizing an electric strike to unlock the door (FIG. 5), and providing an opening mechanism which is substantially free of being mechanically connected to the emergency exit door (FIG. 8). It is important not to hinder or obstruct the emergency exit and not alter the main function of door, which is for emergency exiting. Further, the providing step which is substantially free of being mechanically connected to the door, allows a field worker to push and swing the door fully open, to keep such door out of the way during field work or emergency exit, for example (FIG. 8).

In more detail, the providing step 30 can include: providing a plunging mechanism to contact the emergency exit door to push in a substantially outwardly direction; and providing a receiving interface for contacting the plunging mechanism, operatively connected to an inside of the emergency exit door (FIG. 6). Preferably, a minimal friction pad or interface, such as a Teflon-like pad is provided for protection to the door and reduces friction for pushing and sliding, for smooth and a substantially non-binding opening movement.

In a preferred embodiment, the interface includes a substantially concave cup complementarily constructed to receive a portion of a roller of the actuator (FIGS. 13-16). This construction can substantially eliminate a side load to the actuator, for enhanced useful life to the actuator, while maintaining detachability as well, as detailed herein.

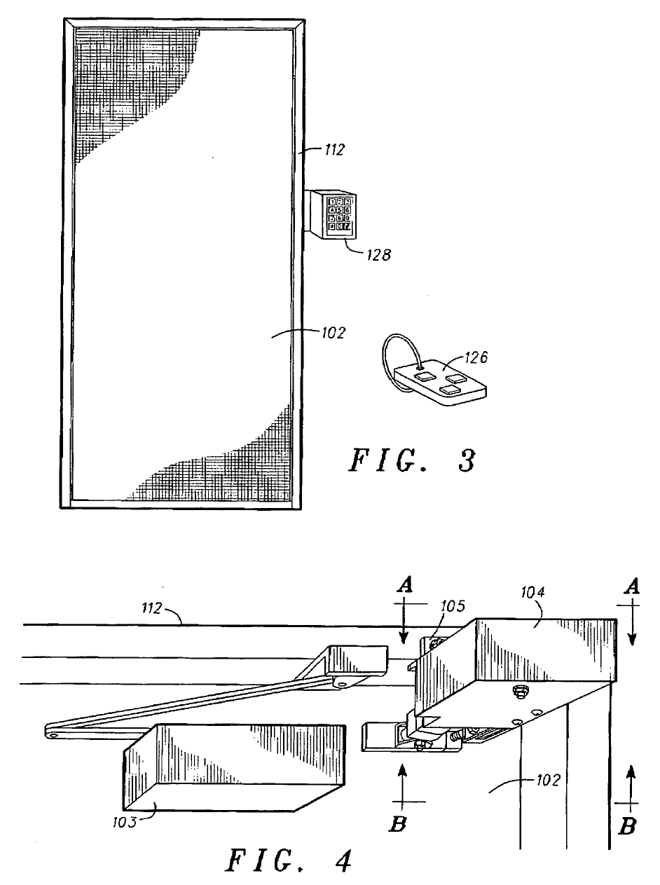

In one embodiment, the actuating step 30 includes a wired device, such as a keypad or a wireless device, such as an RF key fob, etc. for actuation, for example (FIG. 3). As will be appreciated by those skilled in the art, various types of RF communication devices can be used as means for wireless communication. In a preferred embodiment, the actuating step 30 includes providing an RF key fob with at least one of an open signal, an alarm disable signal, a re-activate alarm signal and a panic signal.

In a preferred embodiment, the actuating step 30 further includes activating the electric door strike mechanism to release a pivoting structure of the door strike mechanism, to allow the door to open (FIG. 5); and pushing the door in an outwardly direction thereafter (FIG. 6). This is necessary, as it should be noted, that the door herein is typically an emergency exit door, that typically cannot be opened from the outside, without first activating the door strike mechanism before opening such door.

Also in a preferred delivery system 5, a providing step may include a substantially inwardly directed force, to maintain the door in a fully closed position, until activated. This force utilizes magnets strategically positioned, connected to and partially embedded in proximity to a door jam, which help to maintain such an inwardly directed force on a metal door, for example (FIG. 5). In addition, this force does not adversely affect the emergency exit door and maintains the door in a properly closed position. More specifically, this structure advantageously helps to eliminate outward force on the door, which could cause the door strike mechanism to be inoperable. When there is a certain threshold outward force, such as an excessive in-building air pressure, or boxes stacked against the door, the solenoid of the electric door strike mechanism may not be strong enough to release the mechanism, causing it to be inoperative. This problem is resolved by the use of the providing step as detailed herein (FIG. 5).

In one embodiment, the system 5 further comprises providing a cushion mechanism to minimize mechanical shock, in the event the door is mechanically shocked, jarred, crashed into, or otherwise hit intentionally or by accident, for example (FIGS. 11 and 12). In an electrical embodiment, as shown in the figures, damage can occur to the actuator if there is an excessive mechanical shock to the door and actuator, in the event that a cushioning mechanism is absent. Similarly, when the actuator is a pneumatic mechanism, the cushioning mechanism is provided by the air pressure in the system, otherwise internal to the mechanism.

Also in one embodiment, the system 5 further comprises positively tracking and time stamping the opening and closing of the door, travel through the opening, logging the duration when open, and management for lighting the desired area. Further, the system 5 can comprise sensing or counting the number of times a person goes through the door opening, which can be desirable for tracking of field and delivery activity. And, the system can comprise providing battery back-up and a charging system for the battery back-up to power the system 5, a security system and independent battery powered lighting, if desired, in certain applications.

In addition, the system 5 can further comprise providing an interface with a security system for providing a fully integrated lock and alarm system.

Referring to FIGS. 2 and 3, in it's simplest form, an emergency exit door delivery management system (DDMS) 100 adapted for use with a conventional emergency exit door 102, is shown. The conventional emergency exit door includes a so called “panic bar” 101, and a door closure mechanism 103, both are preferred or required in one embodiment, for the DDMS 100 to operate properly. The DDMS includes: a door opener mechanism 104 for pushing the emergency exit door 102 open; an electric door strike 110 mountable to a door frame 112 to release the panic bar latch; a controller (or control box) 120 electrically connected to the door opener 104 and the door strike 110; an activation device, such as a keypad 128 or an RF key fob 126; and optionally a motion sensor 132. Advantageously, this system and structure enables the system as detailed in FIGS. 1 and 2. Advantageously, the system 5 and DDMS 100 are cost effective and retrofitable systems which can be adapted for use in already installed sites and applications.

In a preferred embodiment, the control box 120 includes: a backup battery, a wiring harness with appropriate connectors, and a controller board with a microcontroller, memory, real-time clock, power supply, backup battery charging circuit, A/D converter to measure system voltages, temperature sensor, input and output interfaces, a communication interface (such as an RS-232), an RF keyfob signal receiver with an internal or external antenna, door opener mechanism power driver circuit, and a keypad interface.

All drawings described below, are shown in connection with an emergency exit door with hinges on the right side. As will be appreciated by those skilled in art, the DDMS 100 could also be used with the door having hinges on the left side and with various pivot enabling door structure, for example, and with other changes and modifications, while staying within the scope of the instant teachings.

FIG. 4 shows a view of the top corner near the hinges of the emergency exit door 102. This figure also indicates the locations of two closer views: A-A and B-B used in later figures. The door opener mechanism 104 is firmly mounted to the emergency exit door frame 112 using a steel or thick aluminum bracket 105. The bracket 105 needs to be able to support the door opener mechanism 104 during the door opening operation, and sustain any potential abuse. The door closure 103 provides continuous force to keep the emergency exit door 102 closed and is essential for the DDMS 100 to work, since the door opener mechanism 104 is not attached in any way to the door 102, and it provides an opening force only (in a preferred embodiment). This opening force needs to overcome the closing force from the door closure 103, and also magnetic force provided by magnets 109 near the electric strike, as shown in FIG. 5.

FIG. 5 represents a part of the emergency exit door 102 near the panic bar 101 with a latch 116, and a door frame mounted electric strike 110 with a gate 118 controlled by an internal solenoid. There are two magnets 109 mounted on the door near the strike 110 to provide an additional force to keep the door tightly closed and make sure that the panic bar latch 116 is not touching the strike electric gate 118 when it needs to be energized to release the latch 116 during the opening process. As an alternative, the magnets 109 could be mounted on the door frame 112 near the strike 110. If either: the emergency exit door 102, or the door frame 112 are not made of steel, a small steel plate mounted on the opposite side is preferably provided for the magnets 109 to work properly with the door, as detailed herein.

FIG. 6 to 16 show the A-A views of the door opening mechanism using an electric actuator, which is not attached in any way to the emergency exit door. A typical opening mechanism 104 assembly contains: a linear actuator (preferably either electric or pneumatic) with an interface adapter 136 to push the door open when the actuator is energized, a door position sensor 130, a bracket to attach the assembly to the door frame, an assembly cover, and in the case of a pneumatic system, it may also contain an air compressor, a pressure regulator, air valves, filters, and air hoses. As an alternative, the pneumatic devices supporting the air cylinder actuator, could be mounted in a separate box, or even in the control box 120 together with the system electronics. In one embodiment, shown in FIG. 6, the linear actuator interface adapter may contain a force alignment shoe 134 attached to the movable distal arm 108, and the door may be configured with a slider pad 136, made out of Teflon, or a similar material. Another embodiment is provided in FIG. 13, where a force centering roller 144 and a specially shaped, complementarily configured, force centering adapter 146, attached to the door, are used to interface the linear actuator 106.

FIG. 6 shows the door 102 in the closed position and the linear actuator 106 with the distal arm 108 retracted. When a delivery or service is initiated, a delivery or field worker sends or initiates a request to open the emergency exit door 102, by either pressing the RF key fob 126 button, or punching a code on the keypad 128. The RF key fob signal is received through the antenna 124 and the RF receiver inside the box (FIG. 2). At this time, the controller may disable the alarm, turn the lights on, enable motion sensor 132, if those options are selected. It will energize the electric strike 110 to release the panic bar latch 116, and a fraction of a second later it will activate the linear actuator 106. If the pneumatic system is used, the controller may need to turn the air compressor on and open the air valve to let the air enter the air cylinder. The linear actuator 106 extends the movable distal arm 108, which forces the door 102 to open, is shown in FIG. 7. The length of the movable distal arm 106 determines the opening angle of the door 102. The angle could be as small as 15 deg, or as large as 90 deg. Since the door is not attached to the movable distal arm 106, it could be pulled out and kept open, as desired by the user (FIG. 8). In a preferred embodiment, after a predetermined time, the movable distal arm 106 retracts back. In the case of the pneumatic system, after a predetermined time, the air pressure is released from the air cylinder, and the pressure release valve is kept open until the door 102 is fully closed.

FIG. 9 shows that the emergency exit door 102 can always be opened manually, no matter what the position of the door opener mechanism is.

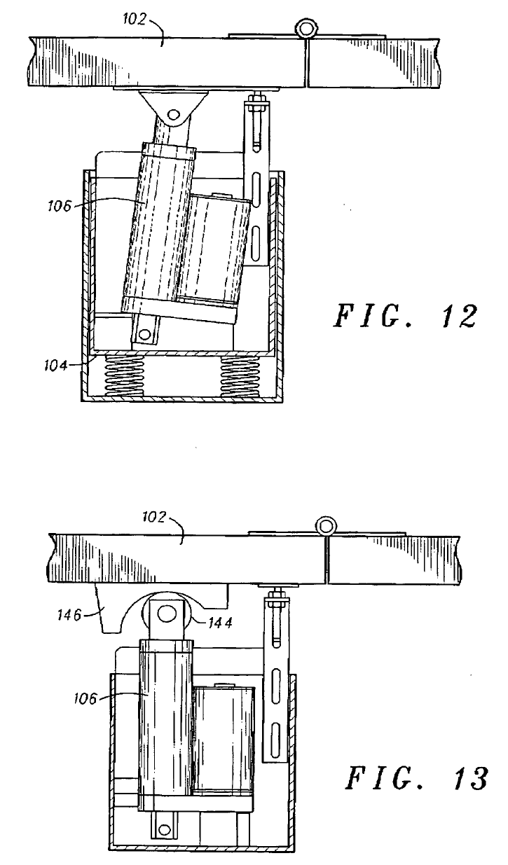

FIG. 10 shows optional spring shock absorbers 142 to the door opener mechanism 104. This option will protect the linear actuator 106 from damage in case there is an obstruction behind the door, or if the operator hits the door 102 with a delivery cart, while the movable distal arm 108 is still in the extended position. FIGS. 11 and 12 show the possible scenario, when the door 102 is being open and then forcefully closed with the distal arm 108 still extended, and the shock absorbers 142 protecting the linear actuator 106 from damage.

If the door 102 needs to be open to 45 deg or more, a preferred embodiment includes use of the force centering roller 144 and the force centering adapter 146, as described previously (FIG. 13).

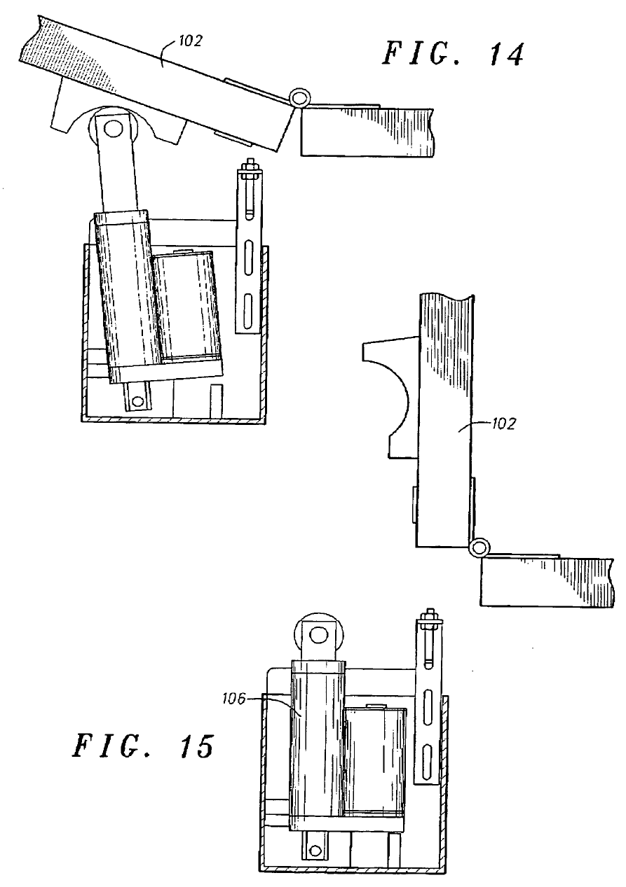

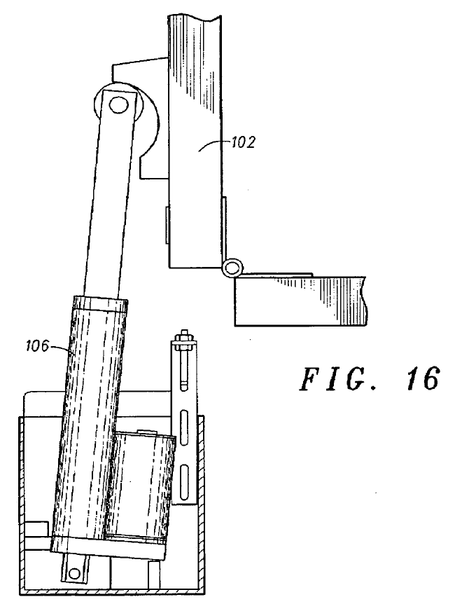

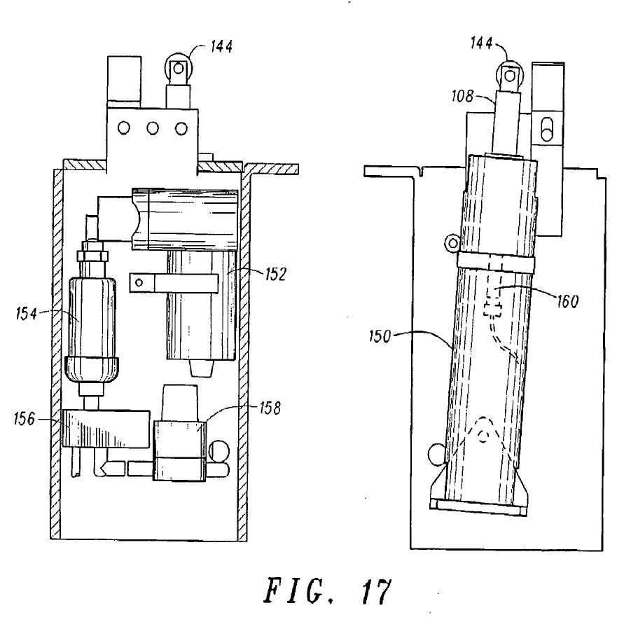

FIGS. 13, 14,15, and 16 show a typical DDMS operation with movable distal arm 106 in various positions. In a preferred embodiment, the distal arm 106 moves to the fully retracted position after a predetermined time (FIG. 15), and the door 102 can still be kept open.

The pneumatic version of the door opening mechanism 104 is presented in FIG. 17. It contains: an air compressor 152 to provide compressed air during the door opening process, a filter/water separator 154 to remove any moisture from the compressed air, a 2-way valve 156, with its normally open port used for the compressed air to pass to a pressure regulator 158 which limits the air pressure to maximum set by the regulator dial, and an air cylinder 150 used as a linear actuator (View B-B). A door position sensor 130 is used to determine if the door 102 is closed, and an air cylinder position sensor 160 is used to determine when the door is open, as required by the system—a locator band with the sensor 160 is adjustable to set the maximum opening angle. The electronic controller 120 turns the compressor 152 on for the time needed to open the door, or until the internal preset time expires. The system could be setup to have the door 102 partially, or fully open during this process. The door 102 will close automatically after certain amount of time, determined by another internal timer. This time could be as long as, for example, 30, 60 or 90 seconds, or any other time determined by the user. The door 102 may also become closed by the operator sending a close door request. In one embodiment, the close door request signal may be sent by pressing an RF key fob button. When the close door request is provided, the electronic controller activates the 2-way pressure relief valve 156 with the normally closed port open to atmosphere. This activation releases the air pressure from the air cylinder 150. Closing of the door 102 in the DDMS 100 always requires the closure 103 to move the door 102 to the closed position. If there is a restriction preventing the door 102 to reach its closed position, the controller 120 will maintain the 2-way pressure relief valve 156 energized to continue bleeding the air from the air cylinder 150, until the door 102 is closed. Door closing requests initiated by the user, deactivates the DDMS 100, and the open pressure relief valve 156, until the door 102 is closed.

If the actuator 106 fails to open the door 102 within a given time, it is possible to send another opening request and the DDMS 100 will try to correct the problem. It is desirable for the user, however, to verify the reason of the opening failure. Once the actuator position sensor detects the distal arm fully extended, the further opening requests are not allowed.

The controller 120 includes memory to record the time and duration of when the door has been opened. This is beneficial, as this provides the time of the delivery and duration, to track field personnel efficiency, time stamping if an incident occurs, etc. Likewise, the DDMS 100 can further comprise a motion sensor 132, as shown in FIG. 2, for tracking field and delivery activity through a door opening of the emergency exit door 102.

In another embodiment, the controller 120 controls a charging of a system backup battery, if the main power source voltage meets an appropriate threshold. If there is a power outage, for example, the DDMS 100 would still operate, and deliveries would then not be interrupted or delayed in such instances.

The DDMS 100 can be integrated with an alarm system coupled to the controller 120, for enhanced security.

FIG. 18 is a prior art daisy chain locking arrangement for allowing access to various disparate groups, such as field workers, access to a predetermined location. A series of mechanical keyed and combination padlocks or a daisy chain of locks, provides very little access control and management. Keys can be lost and combinations cannot be controlled. Disadvantageously, a terminated employee or contractor continues to have access to a facility when he or she retains a key or remembers a combination.

FIG. 19 is an elevated perspective view of an exemplary secure site, in the form of a remote cell tower site, utilizing a facility access management system (FAMS), showing a fenced compound, secure building, shed and lockers, each with strategically positioned access points.

The secure site 200 includes a fence 202, defining a secure compound 204, a gate 206 with a mechanical lock 208, building 210, and shed 212. The site 200 requires utility feeds, such as power, gas, telephone, internet cable and water. Rural and urban sites 200 often have road side barriers 214 including a chained entry 216 attached to two poles with a daisy chain 218 of locks, or several mechanical locks, to open and lock the roadside barrier entry, for vehicular travel, similar to as shown in FIG. 18.

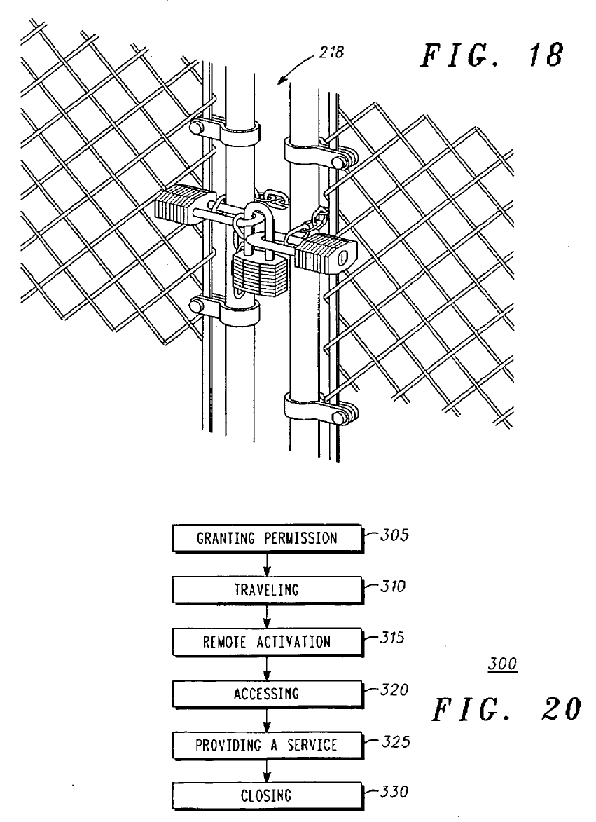

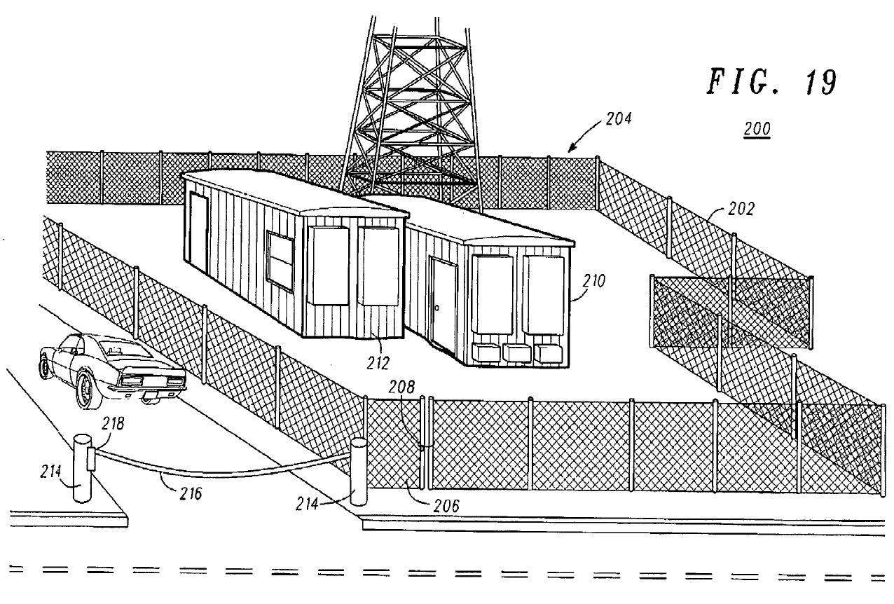

FIG. 20 is a flow diagram of an enhanced delivery system 300 for field service providers, in accordance with the instant invention. In its simplest form, the delivery system 300, can comprise the steps of: granting 305 permission to a service provider to provide a designated service at an assigned location; traveling 310 to the assigned location to provide a service; remotely actuating 315 an access point to gain access to a restricted area; accessing 320 the restricted area through the access point; providing 325 a service in connection with the restricted area; and closing 330 the access point after accessing the restricted area. This system facilitates and simplifies service providers access to and from restricted areas, and routinizes the service process for enhanced efficiencies. It is adapted to outsourcing of various services, without the need of having a person at a site to let them in, which allows for greater flexibility for service providers, as they can provide services at off hours or non-peak times.

The permission granting step 305 can include providing limited access rights to a restricted area based on the type of service to be performed. Thus, for example, a grounds keeper could be allowed limited restricted access through a road side access point, to shovel sidewalks, salt walks and parking lots, mow lawns and like, but would not be provided access to a building and certain lockers. Similarly, a utility service provider could be provided limited access to an area necessary to perform ones designated task, which could include access through a gate, door(s), shed and particular locker, to troubleshoot and/or maintain such utility. Likewise, another worker could be provided unlimited access to the grounds or compound, but only at designated times, for example.

In more detail, the permission granting step 305 can include pre-certifying and ranking the service provider, such that the service provider has partial or full access to a site in connection with the service to be performed, by appropriately programming a RF key fob, for example.

The remote actuating step 315 can be implemented in a variety of ways, such as: receiving an open request from an RF key fob operated by a service provider in proximity to a restricted area; and receiving an open signal from a service center.

In a preferred embodiment, the remote actuating step 315 includes configuring an access point with a receiver, to receive an RF communication signal to open the access point, from an RF device, such as an RF key fob configured to send a signal to open. Such a system provides a simple and cost effective way to manage keys and access to secure areas via RF key fobs, since such RF key fobs are programmable. This arrangement avoids the need for a daisy chain of mechanical locks.

In one arrangement, the remote actuating step 315 includes providing a wired device, such as but not limited to a keypad, or a wireless device for actuation, for additional or alternative ways of gaining access. A mechanical key can be used for access as necessary.

In a preferred embodiment, a service center is coupled to one or more access points, and is capable of monitoring activity related to the access point(s). Advantageously, tracking tampering, openings, attempted openings and closings, and logging and time stamping the duration of each, allows enhanced capabilities in analyzing access point activities and work provided by service providers, for example.

In one arrangement, the access points further include sensing devices with time stamping and proximity sensing, to record the time and duration a service provider was/is in proximity to the access point. Thus, the number of times a person goes through an access point can be recorded, for security recording, productivity and efficiency analysis and matter investigations, such as theft or loss of property investigations.

Access points can be provided with power through normal AC plug and/or with battery power, for additional flexibility.

The system 300 can further include interfacing with one or more of a security system and service center, for enhanced security and monitoring of activity. In more detail, the system 300 and/or service center can be configured to positively identify each opening request, determine whether it is allowed to open the access point at the given time, perform the allowed opening request, and store the request information in an internal event memory. Such information can be monitored real time by security personnel or retrieved later by a system administrator, control center, etc. for analysis, productivity monitoring, matter investigations and the like. For example, if an access point is left open for a predetermined threshold time, an alarm or warning signal can be sent to a control center, to investigate. Additional monitoring devices, such as cameras and the like, can be used with the system 300. These can be used for investigations and further monitoring as deemed appropriate. As should be understood, cameras could be used in a high crime/vandalism area, whereas in other areas it may not be deemed necessary.

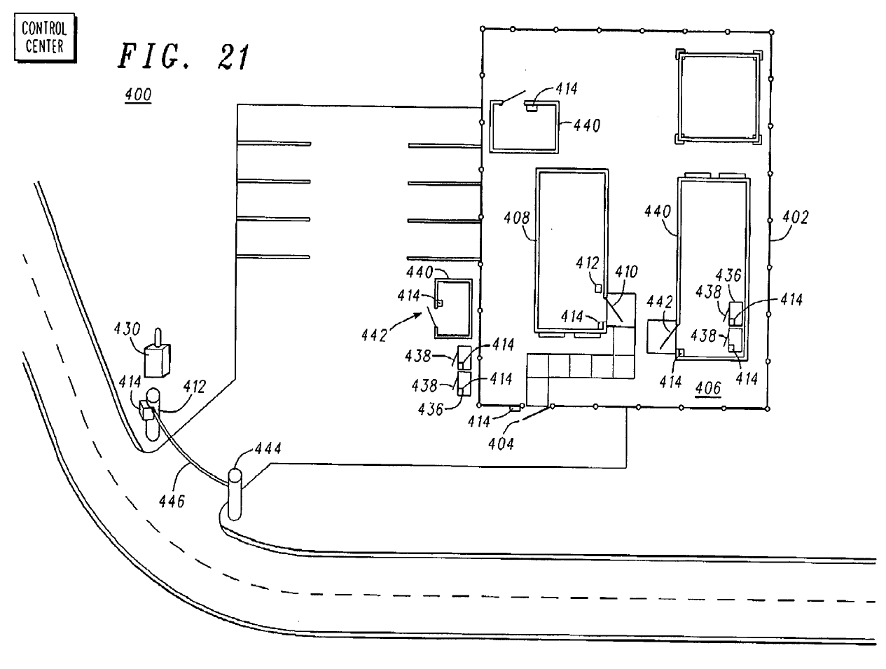

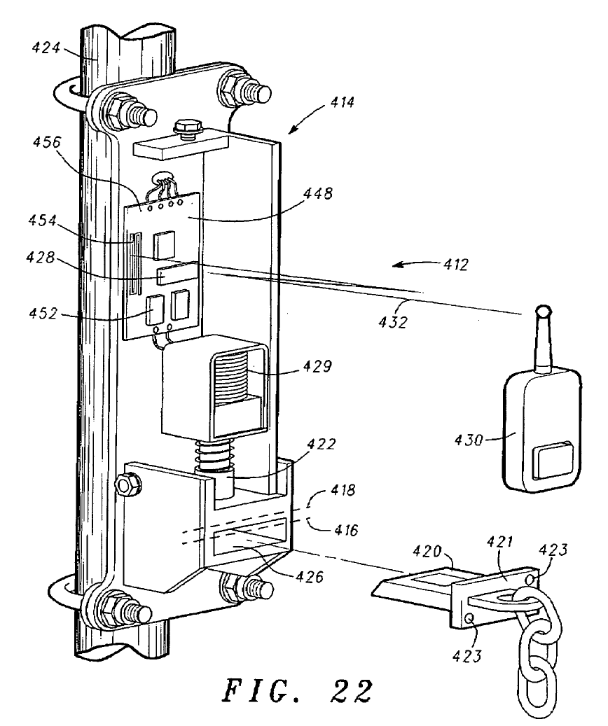

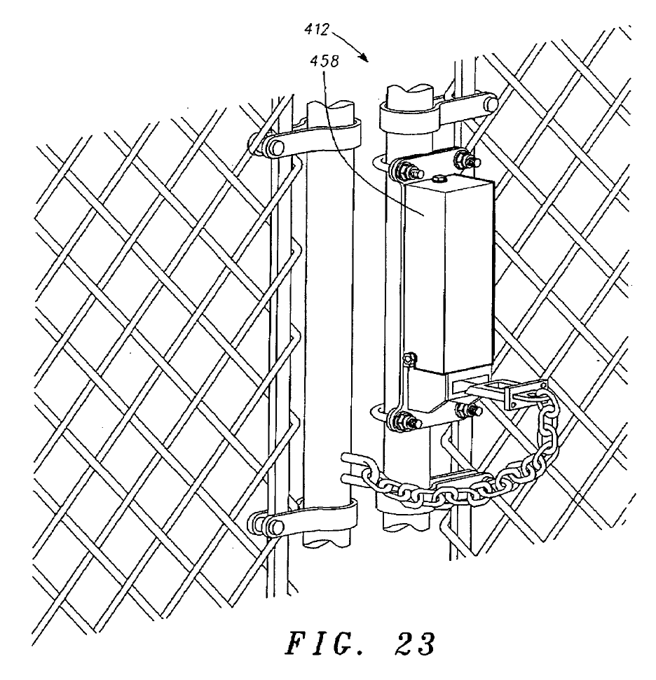

FIG. 21 is a top view of an exemplary site utilizing a facility access management system (FAMS) 400, showing a fenced compound, secure building, shed and lockers, cell tower, strategically placed access points and the like. In its simplest form, the FAMS system 400, can include: a fenced area 402 having a lockable opening 404, defining a restricted compound 406; a building 408 with a lockable building opening 410, defining a restricted building, and an access point 412.

An exemplary access point 412 is shown in FIG. 22 and can include: a locking mechanism 414 having a locked condition 416 and a release condition 418, including a cuff 420 or a strike mechanism (not shown) attached to a secure structure 424, and having an opening 426 configured to receive the cuff 420; a controller 428 electrically connected to an actuator 429, preferably a motor or solenoid, and locking pin 422; a remote activator 430, such as a key fob, can provide a signal to the controller 428 when the remote activator 430 is triggered, to unlock or release the locking pin 422, via the actuator 429, to open the access point 412. In one embodiment, all of the accessible openings include an access point such as those detailed herein, including but not limited to, the lockable opening 404 and building opening 410.

As should be understood by those skilled in the art, the access point disclosed herein can be modified to meet almost any particular application, without departing from the spirit and scope of the invention. For example, the access point 412 can be modified to connect to any kind of opening to restrict access to an enclosure. For example, the locking mechanism 414 in FIG. 22 can be securely fastened, connected and positioned in a shed, cabinet, file, locker, building or any other suitable enclosure, by bolting or securely fastening to a secure structure 424, such as a wall or reinforced area around an enclosure. In such embodiment, the locking mechanism would be recessed to provide a substantially secure tamper resistant housing exterior for the enclosure. Further, the latch 420 can be securely connected to a door through any suitable manner, such as through fasteners, such as bolts fastened perpendicular through face 421 openings 423. Thus, this embodiment would have the face 421 securely connected, parallel and flush with a door. This embodiment would not include a loop and chain on the face 421, as shown in FIG. 22. Alternatively, the locking mechanism 414 can be placed on a door and the latch 420 can be connected to a secure structure, in one embodiment.

The FAMS system 400 provides a simple, robust and cost effective way to manage access to rural or urban facilities. Access can be managed by an entity, in-house or outsourced for example, by distribution of RF devices, such as RF key fobs, programmed with appropriate permissions, rather than a series of mechanical keys, such as in the prior art. Thus, grounds keeper service providers could be provided access only to a roadside barrier access point, to perform grounds keeping, such a lawn cutting and plowing and salting of areas around a secure compound, for example. Similarly, power, internet, telephone, water and gas service providers can be permitted to access only the areas needed to provide their respective service, by use of an RF device, such as a programmed RF key fob. The access point and RF key fob can be programmed to allow limited or restricted access for certain times and areas, for example. Further, certain employees and contractors can be provided greater access to a facility, at any time or specified times, and such access can be revoked upon termination of ones employment or at any time, as determined by an administrator or control center.

Likewise, in the event a service provider or field personnel is unable to open an access point, such field personnel can contact a control center to trouble shoot, open an access point, etc., which can be accomplished real time.

In a preferred embodiment, the FAMS system 200 further includes at least one or more of: a locker 436 with a lockable locker opening 438, a shed/shelter 440 with a lockable shed opening 442 and a roadside barrier 444 with a lockable roadside barrier opening 446, each equipped with an access point. Advantageously, each service provider is granted certain permissions and access to various areas, based on the service to be performed.

In more detail, the access point 412 as shown in FIGS. 22 and 23, can include a controller including: a microcontroller 428, input and output interfaces 448, a communication interface 450 comprising a transceiver for receiving a signal from the remote activator to open the access point. More specifically, the controller can include memory 452 to record activity related to the access point. And, the controller can also include: a real-time clock, a power management circuit, a communication interface comprising a transceiver for use with an RF device, such as a RF key fob, an external event memory and an antenna. In one embodiment, all such electronics are enclosed in a tamper resistant housing 458 (in FIG. 23) and embedded on a printed circuit board 456 (in FIG. 23).

The FAMS system 400 can further include an alarm system coupled to the controller, to monitor and investigate unlocked conditions, tampering, activating unauthorized open signs when a service provider does not have permission during unauthorized hours, for example. Likewise, the FAMS system 400 can further include motion sensor for sensing and tracking access point activity, by service providers or unauthorized personnel, for example.

Embodiments discussed in the instant disclosure provide the following advantages: The use of a programmable key fob can help to eliminate or minimize the need for service providers to carry mechanical keys. The system provides tracking of attempted use of a deactivated key fob. The system provides remote opening of a gate, by for example an administrator or control center personnel. Remotely control hours of access by individual personnel or service providers. Controlled gate and door opening accessibility for facility personnel by use of a key fob. Gate activity is registered in embedded memory so it can be accessed and audited for management evaluation and tracking. Audit information can include who opened a gate, by the key fob code used, when opened and closed, which user group accessed the compound or location and when an unauthorized entry was attempted.

Those skilled in the art will recognize that a wide variety of modifications, alterations and combinations can be made with respect to the above described embodiments and system, without departing from the spirit and scope of the invention, and that such modifications are to be viewed as being within the ambit of this invention.

1. A delivery system, comprising the steps of:
granting permission to a service provider to provide a designated service at an assigned location;
traveling to the assigned location to provide a service;
remotely actuating an access point to gain access to a restricted area;
accessing the restricted area through the access point;
providing a service in connection with the restricted area; and
closing the access point after accessing the restricted area.

2. The delivery system of claim 1, wherein the granting permission step includes providing limited access rights to the restricted area based on the service to be performed.

3. The delivery system of claim 2, wherein the granting permission step includes pre-certifying and ranking the service provider, such that the service provider has partial or full access to a site in connection with the service to be performed.

4. The delivery system of claim 1, wherein the remote actuating step, includes at least one of: receiving an open request from an RF key fob operated by a service provider in proximity to the restricted area; and receiving an open signal from a service center.

5. The delivery system of claim 1, wherein the remote actuating step includes configuring the access point with a receiver to receive an RF communication signal to open the access point.

6. The delivery system of claim 1, wherein the remote actuating step includes providing an RF key fob configured to send a signal to open.

7. The delivery system of claim 1, wherein the remote actuating step includes providing a wired device or a wireless device for actuation.

8. The delivery system of claim 1, wherein the remote actuating step, includes providing additional actuation devices including at least one of a key pad and mechanical key to access the site.

9. The delivery system of claim 1, further comprising providing a service center coupled to the access point, capable of monitoring activity related to the access point.

10. The delivery system of claim 1, further comprising sensing activities related to the access point.

11. The delivery system of claim 1, further comprising providing battery power for the access opening.

12. The delivery system of claim 1, further comprising interfacing with at least one of a security system and service center.

13. The delivery system of claim 1, further comprising providing a service center configured to positively identify each opening request, determine whether it is allowed to open the door at the given time, perform the allowed opening request, and store the request information in an internal event memory.

14. A facility access management system, including:
a fenced area having a lockable opening, defining a restricted compound;
a building with a lockable building opening, defining a restricted building; and
an access point including a locking mechanism having a locked condition and a release condition including a latch and a door strike mechanism mountable to a secure structure having an opening configured to receive the latch;
a controller electrically connected to the locking mechanism;
a remote activator having a triggered condition, which provides a signal to the controller when the remote activator is triggered, to unlock the locking mechanism, to open the access point, wherein the lockable opening and building opening are equipped with the access point.

15. The system of claim 14, further comprising at least one of a locker with a lockable locker opening, a shed with a lockable shed opening and a roadside barrier with a lockable roadside barrier opening, equipped with the access point.

16. The system of claim 14, wherein the controller includes: a microcontroller, input and output interfaces, a communication interface comprising a transceiver for receiving a signal from the remote activator to open the access point.

16. The system of claim 14, wherein the controller includes memory to record activity related to the access point.

17. The system of claim 14, wherein the controller includes: a microcontroller, a real-time clock, a power management circuit, input and output interfaces, a communication interface comprising a transceiver for use with an RF key fob, and an external event memory.

18. The system of claim 14, further comprising at least one of:
an alarm system coupled to the controller reacting to an unlocked condition for over a certain threshold duration, tampering, activating open signal during a restricted period;
a motion sensor for sensing and tracking access point activity; and
a stationary actuator including at least one of a pneumatic driver, solenoid driver and motor driver.

19. The system of claim 14, wherein the remote activator includes an RF key fob having a triggered condition, configured to provide an open signal to the controller when the RF key fob is triggered.
